(19) United States
(12) Patent Application Publication
(10) Pub. No.: US 2026/0208742 A1
(43) Pub. Date: Jul. 23, 2026

(54) VEHICLE CONTROL DEVICE

(71) Applicant: HONDA MOTOR CO., LTD., Tokyo (JP)

(72) Inventors: Ryota Yamasaki, Tokyo (JP); Sadahito Kajihara, Tokyo (JP)

(73) Assignee: HONDA MOTOR CO., LTD., Tokyo (JP)

(21) Appl. No.: 19/140,596

(22) PCT Filed: Dec. 23, 2022
(86) PCT No.: PCT/JP2022/047770

§ 371 Date: Jun. 18, 2025

(51) Int. Cl. B60W 30/20; B60W 10/02; B60W 10/06; B60W 10/08; B60W 20/40

(52) U.S. Cl. CPC B60W 30/20; B60W 10/026; B60W 10/06; B60W 10/08; B60W 20/40; B60W 2030/206; B60W 2510/0283; B60W 2510/0604; B60W 2710/024; B60W 2710/083

(57) ABSTRACT

When switching from a vibration damping control implementation state (in which the lockup clutch (134) is engaged and motor vibration damping control is implemented) to a vibration damping control non-implementation state (in which the lockup clutch (134) is put into a slip state and motor vibration damping control is not implemented, a command is issued to the lock-up clutch (134) to transition from an engaged state to a slip state, and motor vibration damping control is continued until the transition to the slip state is completed, and when it is determined that the transition to the slip state is completed, the motor vibration damping control is terminated.

### TECHNICAL FIELD

This invention relates to a vehicle control device.

### BACKGROUND ART

Conventionally, as shown in, for example, Patent Document 1, in a hybrid vehicle that can run on the power of at least one of an internal combustion engine or a motor (electric motor) connected to the internal combustion engine, a technology has been disclosed that suppresses torque vibration of the internal combustion engine by generating a damping torque in the form of a square wave that is in reverse phase to the torque generated during the explosion cycle of the internal combustion engine from the motor. In addition, Patent Document 2 discloses a technology that uses a motor to suppress engine vibration in the damping implementation area where the engine speed is lower than the predetermined upper limit for damping implementation and the intake manifold vacuum is higher than the predetermined lower limit for damping implementation (absolute value of the vacuum is larger).

In a vehicle equipped with a lock-up clutch in the power transmission path from the internal combustion engine to the drive wheels, the lock-up clutch is engaged to efficiently transmit the power of the internal combustion engine to the drive wheels and enable driving. Therefore, the fuel efficiency of the vehicle can be improved by increasing the opportunities to engage the lock-up clutch. However, on the other hand, if the lock-up clutch is engaged when the torque vibration of the internal combustion engine is large, such as when the engine is idling in a so-called cylinder deactivation engine, the torque vibration is transmitted to the drive wheels via the lock-up clutch, and the NV (noise, vibration) characteristics of the vehicle may deteriorate. Therefore, it is desirable to improve fuel efficiency while avoiding deterioration of the vehicle's NV characteristics.

In vehicles that use motor-based vibration control (motor vibration control) to control engine vibration as described above, there is a concern that the NV characteristics of the vehicle may deteriorate due to a sudden fluctuation in the torque output to the drive wheels when the motor vibration control is switched off from the vibration control state in which the motor vibration control is being implemented and the state is switched to the non-vibration control state. In particular, when the above-described vibration control state is switched to the non-vibration control state for reasons related to vehicle control, such as a decrease in the battery's SOC, there is a risk of fluctuations in the torque output to the drive wheels at a timing that is not intended by the vehicle driver. Therefore, it is desirable to perform the switching from the above-mentioned damping state to the non-damping state while also using slip control to slip the lock-up clutch.

However, even if a command is issued to change the slip ratio of the lock-up clutch at the stage where a command to switch from the damping state to the non-damping state is issued, due to the problem of the response of the actual slip ratio of the lock-up clutch (the actual value following the indicated slip ratio), a slight time lag occurs before the actual slip ratio of the lock-up clutch decreases, and the torque output to the drive wheels at the time of the above-mentioned switching cannot be suppressed, and there was a risk that the deterioration of the NV characteristics of the vehicle could not be sufficiently avoided.

### RELATED ART DOCUMENTS

### Patent Documents

[Patent Document 1] Japanese Unexamined Patent Application Publication No. 2005-065408

[Patent Document 2] Japanese Unexamined Patent Application Publication No. 2007-296975

### SUMMARY OF THE INVENTION

### Problems to be Solved by the Invention

This invention has been accomplished in light of the above problems, and it provides a vehicle control device that can effectively suppress fluctuations in the torque output to the drive wheels at the timing of switching from the damping state (in which motor damping control is being implemented with relatively simple control) to the non-damping state (in which motor damping control is stopped), and can more reliably prevent deterioration of the vehicle's NV characteristics, with the aim of improving traffic safety while also suppressing a decline in traffic flow.

### Means of Solving the Problems

The present invention, which is designed to solve the above-mentioned problem, is a vehicle control device (30) that controls a vehicle (1), the vehicle control device (30) being equipped with an internal combustion engine (11), an electric motor (12), drive wheels (DW), and a lock-up clutch (134) provided in the power transmission path from the internal combustion engine (11) and electric motor (12) to the drive wheels (DW). The internal combustion engine (11) is configured to be switchable between all-cylinder operation (in which all cylinders are operated), and partial cylinder operation (in which some cylinders are stopped, and the lock-up clutch (134) can be in a clamped state (in which the output from at least one of the internal combustion engine (11) and the electric motor (12) is transmitted to the drive wheels (DW) with high efficiency, and a slip state in which the output is transmitted to the drive wheels (DW) with lower efficiency than the coupling state. When the internal combustion engine (11) is being operated in idling mode, the vehicle control device (30) is capable of performing motor vibration control, which reduces the torque vibration of the internal combustion engine (11) transmitted to the drive wheels (DW), the motor damping control, which outputs a damping torque including a torque in reverse phase to the engine torque output from the internal combustion engine (11). When the vehicle control device (30) switches from the damping control execution state (in which the lock-up clutch (134) is engaged and the motor damping control is executed) to the damping control non-execution state (in which the lock-up clutch (134) is disengaged and the motor damping control is not executed), the vehicle control device (30) issues a command to the lock-up clutch (134) to switch from the engaged state to the slip state, continues to implement the motor damping control until the transition to the slip state is complete, and terminates the motor damping control is complete when it is judged that the transition to the slip state is completed.

According to the vehicle control device of the present invention, when switching from a vibration damping control implementation state (in which the lock-up clutch is in an engaged state and motor vibration damping control is implemented) to a vibration damping control non-implementation state in which the lock-up clutch is in a slip state and motor vibration damping control is not implemented, a command is issued to the lockup clutch to transition from an engaged state to a slip state, and motor vibration damping control is continued until the transition to the slip state is completed, and the motor vibration damping control is terminated when the transition to the slip state is completed, Thus, when switching from a state in which vibration damping control is being performed to a state in which vibration damping control is not being performed, motor vibration damping control ends after the lock-up clutch has completely transitioned to a slip state. This prevents the sudden fluctuation of the torque output to the drive wheels that occurs when the vibration control torque output from the motor stops, and effectively prevents the deterioration of the vehicle's NV characteristics. In other words, with conventional control, there was a risk that the vehicle's NV characteristics could not be sufficiently avoided due to the problem of the response of the actual slip rate of the lock-up clutch (the actual value following the indicated value of the slip rate) when switching from the vibration control implementation state to the vibration control non-implementation state. However, with this invention, by setting the transition time (the time required for state transition) until the transition to the lock-up clutch slip state is completed when switching from the vibration control implementation state to the vibration control non-implementation state, the motor vibration control is terminated after the lock-up clutch has completed the transition to the slip state during the relevant transition time, so that there is no risk of the torque output to the drive wheels suddenly fluctuating as the vibration suppression torque output from the electric motor stops. This avoids fluctuations in the torque output to the drive wheels at a timing that is not intended by the vehicle driver.

In addition, with the present invention, the vehicle control device (30) may be such that the completion of the transition of the lock-up clutch (134) to the slip state may be judged by the fact that the rotational speed difference between the rotational speed (NE) of the input shaft of the lock-up clutch (134) and the rotational speed (NM) of the output shaft of the lock-up clutch (134) has become greater than a predetermined value, or by the fact that the rotational speed ratio between the rotational speed (NE) of the input shaft of the lock-up clutch (134) and the rotational speed (NM) of the output shaft of the lock-up clutch (134) has become less than a predetermined value.

According to this configuration, the completion of the transition to the slip state of the lock-up clutch can be judged by determining that the rotational speed difference between the input shaft and output shaft of the lock-up clutch has reached a predetermined value or that the rotational speed ratio between the input shaft and output shaft of the lock-up clutch has dropped below a predetermined value, thereby enabling more accurate determination of the completion of the transition to the slip control of the lock-up clutch. Therefore, it is possible to more effectively prevent fluctuations in the torque output to the drive wheels at a timing that is not intended by the vehicle driver, thus it is possible to more reliably avoid deterioration of the vehicle's NV characteristics.

In addition, in the present invention, the vehicle control device (30) may determine that the transition to the slip state of the lock-up clutch (134) has been completed when a predetermined time has elapsed from the timing of the instruction to transition to the slip state.

According to this configuration, the completion of the transition of the lock-up clutch to the slip state is determined by the passage of a predetermined time from the timing of the instruction to transition to the slip state, so that it is possible to switch from the state where the vibration damping control is implemented to the state where the vibration damping control is not implemented regardless of the state of the lockup clutch. Thus, it is possible to prevent the unnecessary continuation of the vibration control implementation state due to abnormal engagement of the lock-up clutch and the like.

In addition, in the present invention, when switching from the damping control implementation state to the damping control non-implementation state, a target engagement torque of the lock-up clutch (134) during the period from issuing a transfer command to the lock-up clutch (134) (for transition from engagement state to slip state) until the transfer to the slip state is completed, can be set to be lower than the target engagement torque of the lock-up clutch (134) after the establishment of the state of not implementing vibration reduction control.

According to this configuration, when switching from the vibration control implementation state to the vibration control non-implementation state, the target engagement torque of the lock-up clutch from the engagement state to the slip state is set to be lower than the target engagement torque of the lock-up clutch after the vibration control non-implementation state is established, so that the response of the slip ratio at the time of the transition to the slip state can be improved, and the transition to the slip state can be completed more quickly and reliably. In other words, when switching from the state where vibration control is being implemented to the state where vibration control is not being implemented, it is necessary to complete the transition of the lock-up clutch to the slip state as quickly as possible, so that it is desirable to set the target engagement torque of the lock-up clutch to a value lower than the target engagement torque after the state where vibration control is not being implemented is established, so that the transition to the slipping state can be completed in a shorter time.

The symbols in parentheses above are reference numbers for the corresponding components in the drawings of the embodiments described below.

### Effects of the Invention

According to the vehicle control device of the present invention, by virtue of relatively simple control, the fluctuation of the torque output to the drive wheels can be effectively suppressed at the timing of switching from the damping state in which motor damping control is being implemented to the non-damping state in which motor damping control is stopped, and the deterioration of the NV characteristics of the vehicle can be more reliably prevented.

### BRIEF DESCRIPTION OF THE DRAWINGS

FIG. 1 shows an example of a vehicle in this embodiment.

FIG. 2 shows an example of a transmission in a vehicle in this embodiment.

FIG. 3 is a diagram showing an example of a brake specific fuel consumption (BSFC) in the vehicle of the present embodiment.

FIG. 4 shows an example of motor vibration control.

FIG. 5 shows an example of slip vibration control.

FIG. 6 is a timing chart showing the chronological change in each value during the control when switching from the damping control implementation state to the damping control non-implementation state.

FIG. 7 shows a comparison example with respect to the control of the present invention, and is a timing chart showing an example where the switching from the damping state to the non-damping state is performed for reasons such as the damping control being outside the area where damping control is required.

### EMBODIMENTS FOR CARRYING OUT THE INVENTION

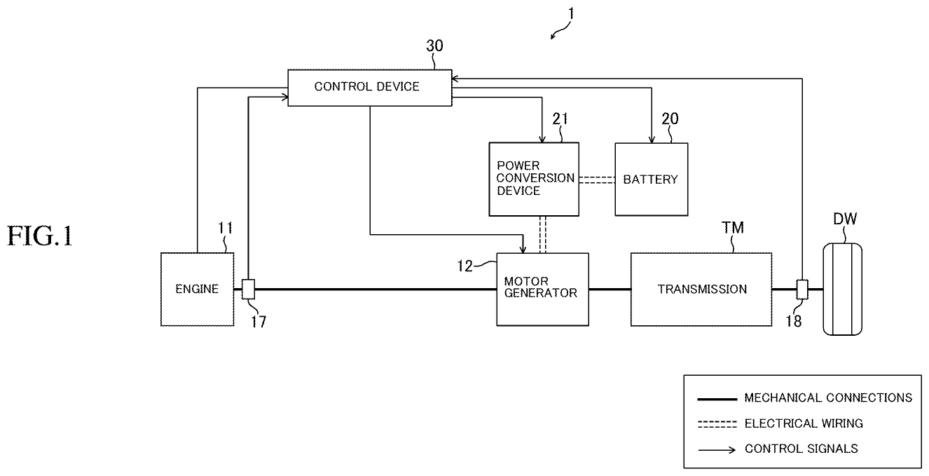

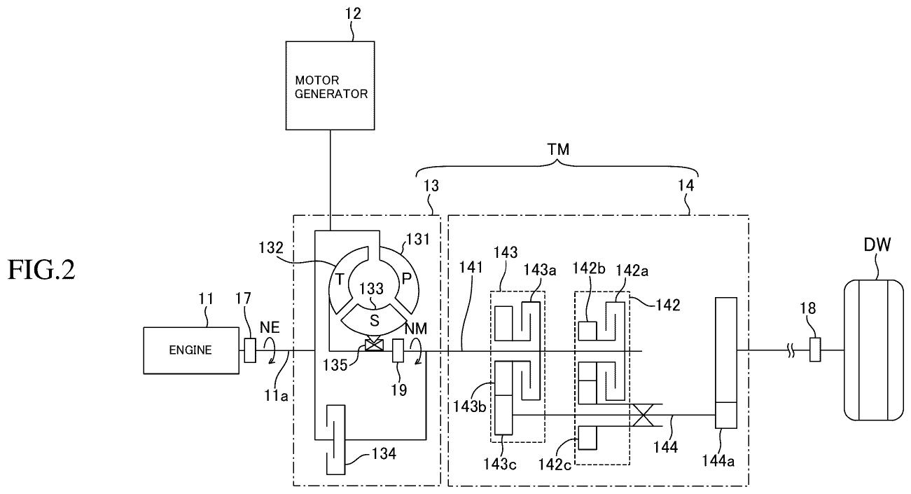

The following describes the embodiment of the present invention in detail with reference to the attached drawings. FIG. 1 shows an example of a vehicle of the present embodiment, and FIG. 2 shows an example of a transmission of the vehicle of the present embodiment. As shown in FIG. 1, the vehicle 1 of this embodiment is a so-called hybrid electrical vehicle (HEV), and is equipped with an engine 11 (which is an example of an internal combustion engine), a motor generator 12 (which is an example of an electric motor), a transmission™ (which is an example of a power transmission device, drive wheels DW, a battery 20, a power converter 21, and a control device 30 which controls the entire vehicle 1. The control device 30 is an example of the vehicle control device of the present invention. In FIG. 1, the bold solid line indicates mechanical linkage, the double broken line indicates electrical wiring, and the solid arrow indicates a control signal.

The engine 11 is a so-called cylinder deactivation engine that is configured to be switchable between all-cylinder operation (in which all cylinders can be operated), and partial cylinder operation (in which some cylinders can be operated while others are deactivated). As an example, engine 11 is a V6 engine with a variable valve timing mechanism (not shown), and is configured so that three cylinders in one bank can be deactivated using the variable valve timing mechanism. In other words, in engine 11, when operating in all-cylinder mode, six-cylinder operation is performed using the six cylinders in both banks, and when operating in deactivated cylinder mode, three-cylinder operation is performed using only the three cylinders in one bank. In addition, engine 11 is configured so that, for example, the opening period, opening/closing timing, lift amount, and the like, of each intake valve can be changed using a variable valve timing mechanism.

Engine 11 outputs the mechanical energy (power) generated by burning the supplied fuel (e.g., gasoline), by rotating the crankshaft 11a (see FIG. 2). Specifically, engine 11 is provided with an injector (not shown). The injector is controlled by the control device 30 using, for example, pulse width modulation (PWM) control, and supplies fuel to the engine 11. The power output from the engine 11 is transmitted to the drive wheels DW via the transmission™, which is mechanically connected to the engine 11, and is used to drive the vehicle 1.

In addition, engine 11 is also mechanically connected to motor generator 12. Motor generator 12 is, for example, a three-phase alternating current motor, and functions as an electric motor that outputs power when supplied with electricity. Specifically, the rotor (not shown) of motor generator 12 is connected to the crankshaft 11a of engine 11. Therefore, the crankshaft end torque, which is the torque at the end of the crankshaft 11a of the power plant torque output from the power plant comprising the engine 11 and motor generator 12, is the sum of the torque output from the engine 11 (hereinafter referred to as engine torque) and the torque output from the motor generator 12 (hereinafter referred to as motor torque).

The fact that the engine 11 and the motor generator 12 are mechanically connected will enable motor assist in vehicle 1, in which the driving of the driving wheels DW (i.e., the running of vehicle 1) using the output of the engine 11 is assisted by the output of the motor generator 12.

In addition, because the engine 11 and motor generator 12 are mechanically connected, it is also possible to rotate and drive the motor generator 12 using the output of the engine 11, or to rotate and drive the engine 11 using the output of the motor generator 12. For example, in the vehicle 1, it is possible to start the engine 11 by cranking using the motor generator 12.

The motor generator 12 is electrically connected to the battery 20 via the power conversion device 21. The battery 20 is a battery device that has, for example, multiple storage cells connected in series and is configured to be able to output a predetermined voltage (e.g., 50 to 200 V). Lithium-ion batteries and nickel-metal hydride batteries can be used as the storage cells of the battery 20.

The power conversion device 21 is a device that performs power conversion and is controlled by the control device 30, and is equipped with an inverter and a DC/DC converter (both not shown). For example, the power conversion device 21 converts the direct current power supplied from the battery 20 to three-phase alternating current power and supplies it to the motor generator 12, and converts the three-phase alternating current power supplied from the motor generator 12 to direct current power and supplies it to the battery 20. The motor generator 12 is capable of performing the aforementioned motor assist by being supplied with power from the battery 20 via the power converter 21.

In addition, the motor generator 12 also functions as a generator that generates electricity by being driven by rotation. As mentioned above, the motor generator 12 can be driven by the output of the engine 11, and it can also be driven by the power input from the driven wheel DW side in conjunction with braking of the vehicle 1. The electricity generated by the motor generator 12 is supplied to the battery 20 via the power converter 21 and is used to charge the battery 20.

The transmission™ is a multi-stage transmission with multiple transmission stages (e.g., 7 stages), and is provided in the power transmission path from the engine 11 and motor generator 12 to the driven wheels DW. Specifically, the transmission™ is composed of a torque converter 13 and a gearbox 14, as shown in FIG. 2.

The torque converter 13 comprises a pump impeller 131, a turbine runner 132, a stator 133, and a lock-up clutch 134. The pump impeller 131 is mechanically connected to the engine 11 and the motor generator 12 (specifically, the crankshaft 11a), and rotates as a single unit in conjunction with the rotational drive of these components. The turbine runner 132 has an oil inlet that is located close to the hydraulic oil outlet of the pump impeller 131, and is mechanically connected to the input shaft 141 of the gearbox 14, rotating as one unit with the input shaft 141. The stator 133 is arranged to be sandwiched between the turbine runner 132 and the pump impeller 131, and deflects the flow of hydraulic fluid from the turbine runner 132 to the pump impeller 131. The stator 133 is supported by the housing (not shown) of the torque converter 13 and the like via the one-way clutch 135. The torque converter 13 can transmit power (rotational power) from the pump impeller 131 to the turbine runner 132 via the hydraulic fluid, by circulating the hydraulic fluid in the circulating path formed between the pump impeller 131 and the turbine runner 132.

The lock-up clutch 134 is a clutch that can connect and disconnect the mechanical connection between the engine 11 (specifically, the crankshaft 11a) and the input shaft 141 of the gearbox 14. By engaging the lock-up clutch 134, it is possible to directly transmit the output of the engine 11 to the input shaft 141 of the gearbox 14. In other words, when the lock-up clutch 134 is engaged, the crankshaft 11a of the engine 11 and the input shaft 141 of the gearbox 14 rotate as a single unit.

In addition, the lock-up clutch 134 can also dampen the power (rotational power) from the crankshaft 11a and transmit it to the input shaft 141 by slipping (sliding). In other words, the lock-up clutch 134 can be in a locked state (in which the output from at least one of the engine 11 and the motor generator 12 is transmitted to the driven wheels DW with high efficiency), or in a slipping state (in which the output is transmitted to the driven wheels DW with lower efficiency than in the locked state.

The gearbox 14 includes: an input shaft 141 to which the output of the engine 11 and motor generator 12 is transmitted via at least one of the torque converter 13 and lock-up clutch 134; a plurality of transmission mechanisms 142, 143 that can change the speed of the power transmitted to the input shaft 141; and an output member 144 including an output gear 144a that outputs the power (which has been shifted by one of these multiple transmission mechanisms 142, 143) to the driving wheel DW side. The input shaft 141 is an example of a main shaft.

The multiple transmission mechanisms provided by the gearbox 14 include a first transmission mechanism 142 and a second transmission mechanism 143. The first transmission mechanism 142 includes a first transmission clutch 142a, a first drive gear 142b that rotates as one unit with the input shaft 141 when the first transmission clutch 142a is engaged, and a first driven gear 142c that rotates as one unit with the output member 144. The second transmission mechanism 143 includes a second transmission clutch 143a, a second drive gear 143b that rotates together with the input shaft 141 when the second transmission clutch 143a is engaged, and a second driven gear 143c that rotates together with the output member 144.

In FIG. 2, only the first transmission mechanism 142 and the second transmission mechanism 143 are shown as the transmission mechanisms provided in the gearbox 14, but the gearbox 14 also has other transmission mechanisms (not shown) in addition to the first transmission mechanism 142 and the second transmission mechanism 143.

Whether or not to engage (including the aforementioned slip state) or disengage the clutches (hereinafter simply referred to as the “clutches of the transmission™”) provided in the transmission™, such as the lock-up clutch 134, the first gear clutch 142a, and the second gear clutch 143a, will be controlled by the control device 30.

Returning to FIG. 1, the control device 30 is a device that controls the engine 11, transmission™, and power conversion device 21 and the like. Furthermore, the control device 30 can also control the motor generator 12 via control of the power conversion device 21. The control device 30 may also directly control the motor generator 12 or control the input and output of the battery 20. The control device 30 is realized by an electronic control unit (ECU) that is equipped with a processor performing various calculations, a memory device that stores various information, and an input/output device that controls the input/output of data between the inside and outside of the control device 30. The control device 30 may be realized by a single ECU, or it may be realized by multiple ECUs operating in a coordinated manner.

The control device 30 is connected to various sensors, and the control device 30 controls the engine 11, transmission™, and power converter 21 (i.e., motor generator 12) based on the information input from these various sensors. Examples of sensors connected to the control device 30 include an engine speed sensor 17 that detects the rotation speed of the engine 11 (crankshaft 11a) (hereinafter also referred to as engine speed; see also NE in FIG. 2), a vehicle speed sensor 18 that detects the traveling speed of the vehicle 1 (hereinafter also referred to as vehicle speed), and a main shaft rotation speed sensor 19 (see FIG. 2) that detects the rotation speed of the input shaft 141 (hereinafter also referred to as main shaft rotation speed (see also NM in FIG. 2).

Furthermore, other sensors connected to the control device 30 include an accelerator pedal sensor that detects the amount of operation of the accelerator pedal of the vehicle 1 (hereinafter also referred to as the “AP opening”), a brake pedal sensor that detects the amount of operation of the brake pedal of the vehicle 1, a gear position sensor that detects the gear position of the transmission™, a battery sensor that detects the output and temperature of the battery 20, and an intake pressure sensor that detects the intake pressure (intake pipe pressure) of the engine 11 (all of which are not shown in the figure). In addition, the control device 30 may be connected to an atmospheric pressure sensor (not shown) that detects atmospheric pressure.

For example, the control device 30 derives a target torque (hereinafter also referred to as “crank end required torque”) for the crank end torque, which is the sum of the engine torque and the motor torque, based on the driving state of the vehicle 1. As an example, the control device 30 derives the required torque at the crank end by referring to the vehicle speed detected by the vehicle speed sensor 18 and the AP opening detected by the AP sensor, also by referring to a map that defines the crank end torque required for the vehicle 1 to travel according to the vehicle speed and AP opening. On the other hand, this map is, for example, stored in advance in the memory of the control device 30. The control device 30 then controls the engine torque and motor torque so that the crankshaft end torque becomes the crankshaft end required torque.

In addition, the control device 30 switches the operating state of the engine 11 between all-cylinder operation and idling cylinder operation based on the crank end required torque. Specifically, when the crank end required torque is relatively small, the control device 30 operates the engine 11 in idling cylinder operation, and when the crank end required torque increases to a certain extent, the control device 30 operates the engine 11 in all-cylinder operation. In other words, the control device 30 improves the fuel efficiency of the vehicle 1 by operating the engine 11 in idling mode when the crankshaft end torque demand is small, and secures appropriate crankshaft end torque according to the driving state of the vehicle 1 by operating the engine 11 in all-cylinder mode when the crankshaft end torque demand increases. The specific example of switching the engine 11 operating state by the control device 30 will be described later, so that the explanation here will be omitted.

[Brake Specific Fuel Consumption (BSFC)] The control device 30 also controls the engine 11 by taking into account the brake specific fuel consumption (BSFC). The BSFC is the amount of fuel consumed per cycle of the engine (fuel injection volume) divided by the engine output (net horsepower), and the smaller the value, the better the fuel efficiency.

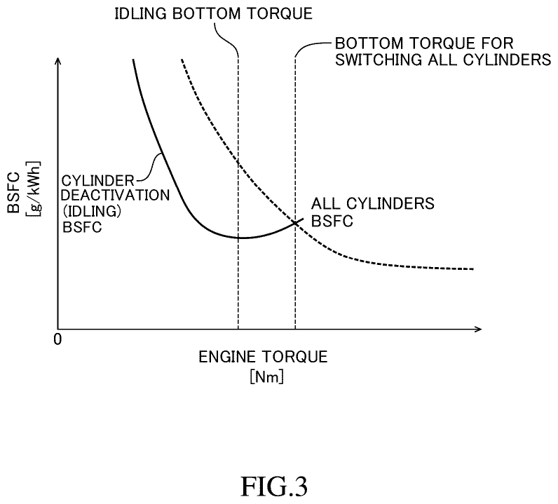

The control device 30 controls the engine torque based on the BSFC. Specifically, the control device 30 controls the engine torque so that the BSFC becomes an optimal value by referring to a BSFC characteristic model that represents the BSFC characteristics of the vehicle 1 which are stored in advance in the memory device and the like of the control device 30.

[BSFC characteristics of the Vehicle 1 of this Embodiment] Here, referring to FIG. 3, the BSFC characteristics of Vehicle I will be explained. FIG. 3 shows an example of the net fuel consumption rate (BSFC) of Vehicle 1 in this embodiment, and in the graph of the same figure, the vertical axis indicates BSFC [g/kWh] and the horizontal axis indicates engine torque [Nm].

As shown in FIG. 3, the BSFC of vehicle 1 when engine 11 is in idling operation, idling BSFC, gradually decreases with increasing engine torque until engine torque reaches idling bottom torque, and then increases with increasing engine torque after idling bottom torque is reached. In other words, when engine 11 is in idling operation, the BSFC value is at its minimum when engine torque reaches idling bottom torque, and fuel efficiency is at its best. In other words, the idling bottom torque is the optimal operating point for fuel efficiency of the engine 11 that is being operated in idling mode.

In addition, although only part is shown in FIG. 3, the BSFC of the vehicle 1 when the engine 11 is operated in all-cylinder mode, i.e., the all-cylinder BSFC, also has the same trend as the idling BSFC. Specifically, the all-cylinder BSFC gradually decreases with the increase in engine torque until the engine torque reaches the all-cylinder bottom torque (not shown, all-cylinder bottom torque>closed cylinder bottom torque), it increases in line with the increase in engine torque after the all-cylinder bottom torque is reached. In other words, when engine 11 is operating at all-cylinder, the BSFC value is at its minimum when the engine torque reaches the all-cylinder bottom torque, and fuel efficiency is at its best.

[Idling bottom assist control] If the opportunity to operate engine 11 so that engine torque reaches the idling bottom torque (i.e., at the optimal fuel efficiency operating point) is increased during idling operation of engine 11, the fuel efficiency performance of vehicle 1 will improve. On the other hand, if operating engine 11 at idling bottom torque prevents the appropriate crank end torque from being secured according to the driving conditions of vehicle 1, hesitation (i.e., the vehicle 1 stalling) may occur, and drivability may decrease.

Therefore, when the engine torque reaches the idling bottom torque while the engine 11 is being operated in idling mode, the control device 30 will execute idling bottom assist control. In idling bottom assist control, the control device 30 increases the motor torque provided for motor assist in accordance with the increase in the required torque at the crank end while maintaining the engine torque at the idling bottom torque. In other words, in the idling cylinder bottom assist control, the control device 30 compensates for the torque that is insufficient for the crank end required torque, by maintaining the engine torque at the idling cylinder bottom torque and using the motor torque. This allows the engine 11 to be operated at the optimal fuel efficiency operating point while ensuring an appropriate crank end torque according to the driving conditions of the vehicle 1. Therefore, it is possible to improve the fuel efficiency performance of the vehicle 1 while avoiding the occurrence of hesitation and the resulting reduction in drivability.

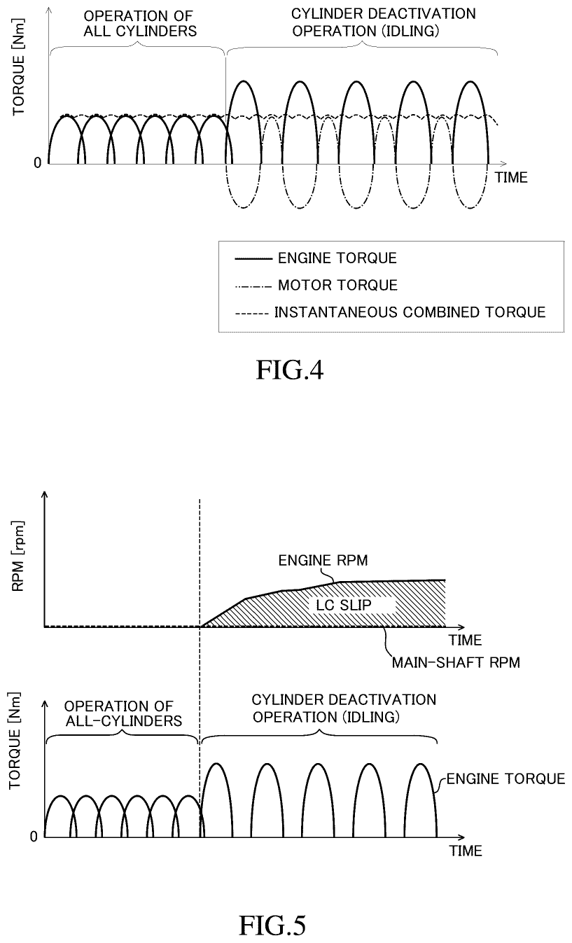

When the idling cylinder bottom assist control is being executed, if the required crank end torque reaches the predetermined all-cylinder switching bottom torque, the control device 30 terminates the idling cylinder bottom assist control and switches the engine 11 operating state to all-cylinder operation. Here, the all-cylinder switching bottom torque is the torque corresponding to the intersection of the idling cylinder BSFC curve and the all-cylinder BSFC curve, as shown in FIG. 3. This allows the operating state of the engine 11 to be switched from idling cylinder operation to all-cylinder operation at an appropriate timing from the perspective of BSFC.

[Torque Vibration of Engine] Next, referring to FIG. 4, the torque vibration of the engine 11 will be explained. FIG. 4 shows an example of motor damping control to be described later, and in the graph of the same figure, the vertical axis indicates torque [Nm] and the horizontal axis indicates time.

As shown by the bold solid line in FIG. 4, when the engine 11 is in idling operation, the amplitude of the torque vibration (hereinafter simply referred to as the torque vibration of the engine 11) generated during the combustion cycle (explosion cycle) of the engine 11 tends to be larger than when the engine 11 is in full operation. The reason why the torque vibration of the engine 11 is larger during idling operation is that the torque output from each cylinder in operation is increased compared to full operation in order to secure an appropriate crank end torque. Furthermore, when idling, the interval between the engine 11 explosions is longer than when all cylinders are operating, so that the frequency of the engine 11 torque vibration is also likely to be lower.

In this way, torque vibrations with large amplitude and low frequency may occur in the engine 11 during cylinder deactivation operation. If such torque vibration is transmitted to the drive wheels DW, it may cause vibration that is uncomfortable for the driver, and may deteriorate the NV characteristics of the vehicle 1.

Therefore, the control device 30 is configured to be capable of executing vibration suppression control that reduces the torque vibration of the engine 11 transmitted to the drive wheel DW when the engine 11 is idling. The vibration suppression control includes motor vibration suppression control that outputs a predetermined vibration suppression torque from the motor generator 12 and slip vibration suppression control that causes the lock-up clutch 134 to slip. The following describes an example of motor vibration suppression control and slip vibration suppression control.

[Motor Vibration Control] In motor vibration control, the control device 30 causes the motor generator 12 to output a vibration suppression torque that includes a torque which is in reverse phase to the engine torque output from the engine 11, as shown by the dotted line in FIG. 4. Specifically, as shown by the broken line in FIG. 4, the control device 30, will have the following operation. Namely, the instantaneous combined torque obtained by combining the torques output at each time from each cylinder of the engine 11 and the motor generator 12 may be such that a vibration damping torque that is approximately the same as that during all-cylinder operation is output from the motor generator 12. This makes it possible to achieve NV characteristics that are almost the same as those during all-cylinder operation even during idling-cylinder operation, as long as the vibration-damping torque of the motor generator 12 is sufficient to counteract the torque vibration of the engine 11.

[Slip Vibration Control] Next, we will explain slip damping control, referring to FIG. 5. FIG. 5 shows an example of slip damping control, and the graph in the figure shows the temporal relationship between engine speed, main shaft speed, and engine torque.

As shown in FIG. 5, the control device 30 can dampen the power transmitted from the crankshaft 11a to the input shaft 141 via the lock-up clutch 134 by executing the slip damping control when the engine 11 is idling, causing the lock-up clutch 134 to slip (shown as “LC slip” in the figure). Thus, the power transmitted from the crankshaft 11a to the input shaft 141 via the lockup clutch 134 can be attenuated.

Specifically, when the control device 30 executes slip damping control, it controls the transmission efficiency of power (hereinafter simply referred to as “power transmission efficiency”) through the lock-up clutch 134 by appropriately controlling the hydraulic pressure supplied to the lock-up clutch 134, while referring to the engine speed detected by the engine speed sensor 17 and the main shaft speed detected by the main shaft speed sensor 19. By executing slip damping control, for example, as shown in FIG. 5, the control device 30 can also maintain a constant main shaft rotation speed even if the engine rotation speed fluctuates.

On the other hand, when the power transmission efficiency decreases due to the execution of slip damping control, in order to drive the vehicle 1 in the same way as when slip damping control is not executed, it is necessary to output more power from the engine 11 and motor generator 12. For this reason, slip damping control can lead to a decrease in the fuel efficiency of Vehicle 1.

Therefore, in order to suppress the decrease in fuel efficiency caused by slip damping control, when the control device 30 executes damping control, it executes motor damping control with priority over slip damping control, and when the deterioration of the NV characteristics cannot be avoided by motor damping control alone, the slip damping control will be executed. In addition, even when the control device 30 executes slip vibration control, it will be executed together with motor vibration control to minimize the amount of reduction in power transmission efficiency that is necessary to avoid deterioration of the NV characteristics.

Specifically, the control device 30 stores a map that has been predetermined in accordance with the crank end required torque and the engine speed for each of the following: a non-vibration control area in which neither motor vibration control nor slip vibration control is performed; a first vibration control area in which motor vibration control and slip vibration control are performed; and a second vibration control area in which motor vibration control is performed and slip vibration control is not performed. The control device 30 refers to this map and determines whether or not to execute only motor vibration suppression control (i.e., whether or not the crankshaft end required torque and engine speed are included in the second vibration suppression area) or whether or not to execute slip vibration suppression control in addition to motor vibration suppression control (i.e., whether or not the crankshaft end required torque and engine speed are included in the first vibration suppression area) based on the crankshaft end required torque and engine speed during idling. The control device 30 then executes motor damping control or motor damping control and slip damping control as necessary based on the results of this judgment.

In addition, in the above-described vibration control, at the timing of switching from a vibration suppression state (where vibration suppression is performed only by the motor vibration suppression control) to a non-vibration suppression state by stopping the motor vibration suppression control, the following operation is performed. Namely, by performing the switching while simultaneously using slip vibration suppression control that causes the lock-up clutch 134 to slip, it is desirable to prevent the torque output to the drive wheels DW from suddenly fluctuating due to the stop of the damping torque of the motor generator 12. However, due to the responsiveness (the ability to track the actual value against the indicated value of the slip rate) of the lock-up clutch 134, there is a slight time lag between the indicated value (target slip rate) of the slip rate of the lock-up clutch 134 and the actual slip rate. Therefore, even if the slip rate command value is changed to move the lock-up clutch 134 from the engaged state to the slip state at the stage when the switching command is given, the lock-up clutch 134 may not be able to sufficiently follow the actual slip rate, and the torque output to the drive wheel DW at the time of switching described above may fluctuate, which may worsen the NV characteristics of the vehicle 1 at the time of switching. In particular, if it is necessary to switch from a damping state to a non-damping state for reasons related to the control of Vehicle 1, such as a drop in the SOC of battery 20, rather than for reasons related to damping, such as the vehicle moving out of the range where damping control is required, there is a risk that fluctuations in the torque output to the drive wheels DW will occur at a timing that is not intended by the driver or passengers of vehicle 1.

To deal with this, in the control device 30 of this embodiment, when the vehicle 1 transitions from implementing damping control to not implementing damping control due to a control constraint (such as a drop in SOC) in the area where damping control is required, the slip control of the lock-up clutch 134 during the transition is appropriately performed to improve the NV of the vehicle 1 at the time of the damping control transition.

Specifically, when switching from the damping control implementation state (in which damping control is implemented with the lock-up clutch 134 engaged) to the damping control non-implementation state (in which damping control is not implemented with the lock-up clutch 134 slipping), a command is issued to the lock-up clutch 134 to shift from the engaged state to the slipping state, and motor damping control is continued until the shift to the slipping state is completed, and motor damping control is terminated when the shift to the slipping state is completed. The following section explains in detail the control when switching from the vibration suppression control state to the non-vibration suppression control state.

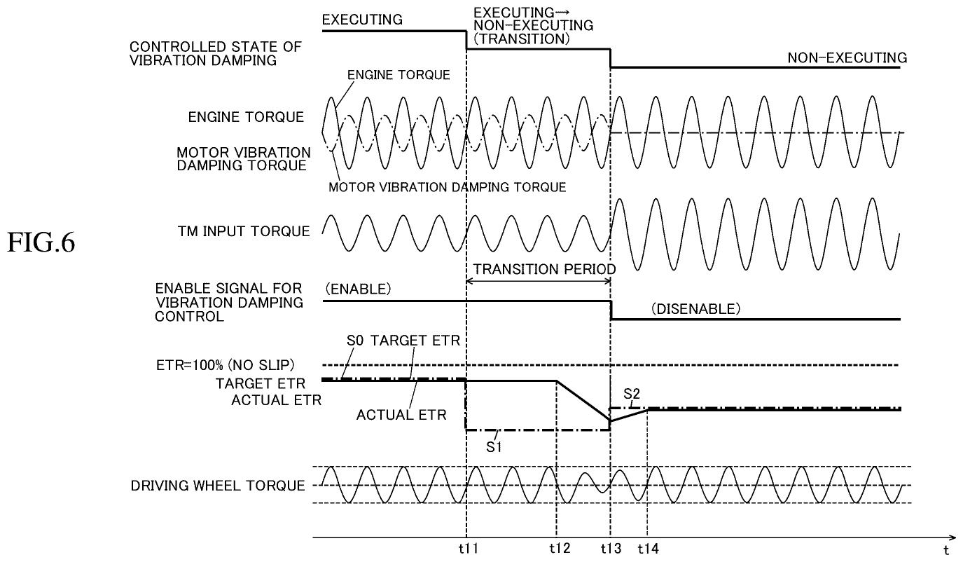

FIG. 6 is a timing chart showing the chronological change in each value during the control when switching from the vibration suppression control state to the non-vibration suppression control state. The timing chart in the figure shows the changes in the damping control state (implementation/transition/non-implementation), engine torque and motor damping torque, transmission™ input torque, damping control enable signal (enable/disable), lock-up clutch 134 slip ratio ETR (target ETR, actual ETR), and output torque to the drive wheels DW (drive wheel torque) over time t. The slip ratio ETR (%) of the lock-up clutch 134 is calculated using the following formula.

$$ETR ( \% ) = ( Transmission TM main shaft rotation speed NM / Crankshaft rotation speed NE ) \times 100$$

The graph in FIG. 6 is a timing chart for cases where the switch from the damping control state to the non-damping control state is performed for reasons related to the control of Vehicle 1, such as a drop in the SOC of the battery 20, rather than for reasons related to damping, such as the engine 11 being outside the range where damping control is required. In this timing chart, before time t11, the motor damping control is being implemented in the damping control implementation state with the lock-up clutch 134 engaged. Then, at time t11, for example, if the SOC of the battery 20 falls below a predetermined threshold value, or for some other reason related to the control of the vehicle 1, it is judged necessary to transition from the vibration control implementation state to the vibration control non-implementation state, and as a result, the vibration control state transitions from the “implementation” state to the “transition” state of implementation→non-implementation. In addition, the target slip ratio (target ETR) of the lock-up clutch 134 is set to S1. This target slip ratio S1 is a value for moving the lock-up clutch 134 into a slipping state, and is a value lower than the target slip ratio S0 of the lock-up clutch 134's previous engagement state (S0>S1). In addition, the target slip ratio S1 is set to a value lower than the target slip ratio (target engagement torque) S2 of the lock-up clutch 134 after the establishment of the state of no implementation of vibration suppression control (S2>S1). In this “transition” state, the output of the vibration suppression torque by the motor generator 12 continues. Subsequently, at time t12, the actual ETR begins to decrease. This causes the lock-up clutch 134 to shift to a slipping state. Then, when it is judged that the shift of the lock-up clutch 134 to a slipping state is complete at time t13, the vibration control state shifts from the “transition” state to the “non-execution” state. The decision to judge that the transition to the slip state is complete is made when the actual slip ratio (actual ETR) of the lock-up clutch 134 (difference in rotational speed between the crankshaft 11a rotational speed NE and the main shaft 141 rotational speed NM) reaches a predetermined value or more. When it is judged that the transition to the slip state is complete at time t13, the vibration control enable signal is switched from “enable” to “disable”, and the output of the motor vibration suppression torque by the motor generator 12 stops. In addition, the target slip ratio of the lock-up clutch 134 is set to the target slip ratio (target engagement torque) of the lock-up clutch 134 after the establishment of the state where the vibration control is not implemented (target slip ratio S2). In the case shown in the figure, the actual slip ratio gradually increases, and at time t14, the actual slip ratio becomes a value that almost follows the target slip ratio S2.

By providing a transition period to the state where the vibration control is not implemented as described above, the output of the vibration control torque by the motor generator 12 stops after the lock-up clutch 134 enters the slip state, so that the torque output to the drive wheel DW becomes stable when the state where the vibration control is implemented is changed to the state where the vibration control is not implemented, as shown in the drive wheel torque in FIG. 6, and the deterioration of the NV characteristics of the vehicle 1 during the transition can be prevented.

In the above explanation, the judgment of the completion of the transition to the slip state is made when the actual slip ratio (actual ETR) of the lock-up clutch 134 (difference in rotation speed between the crankshaft 11a rotation speed NE and the main shaft 141 rotation speed NM) becomes greater than a predetermined value. In addition to this, the judgment of the completion of the transition to the slip state may also be made when a predetermined time has elapsed from the timing of the instruction to transition to the slip state. In this case, a timer that counts down from time t11 in the timing chart in FIG. 6 can be set, and the transition to the slip state can be judged to be complete when the timer counts up.

As explained above, according to the control device 30 of this embodiment, when switching from the vibration suppression control implementation state (in which the lock-up clutch 134 is engaged and motor vibration suppression control is implemented) to the vibration suppression control non-implementation state (in which the lock-up clutch 134 is in the slip state and motor vibration suppression control is not implemented), a command is issued to the lock-up clutch 134 to switch from the engaged state to the slip state, and motor vibration suppression control is continued until the transition to the slip state is complete, while the motor vibration control is terminated when the transition to the slip state is complete. As a result, the motor vibration control can prevent the torque output to the driving wheel DW from fluctuating suddenly by stopping the motor vibration torque output from the motor generator 12, and it can effectively prevent the NV characteristics of the vehicle 1 from deteriorating. In other words, with the conventional control, there was a risk that the deterioration of the NV characteristics of the vehicle 1 could not be sufficiently avoided due to the problem of the response of the actual slip ratio of the lock-up clutch 134 (the followability of the actual value to the indicated value of the slip ratio) when switching from the damping control implementation state to the damping control non-implementation state. In the present embodiment, by setting the transition time (time required for state transition) until the transition to the slip state of the lock-up clutch 134 is completed when switching from the damping control implementation state to the damping control non-implementation state. In this way, the motor damping control is terminated after the transition to the slip state of the lock-up clutch 134 is completed in the said transition time, so that there is no risk of the torque output to the drive wheel DW suddenly fluctuating due to the motor damping torque output from the motor generator 12 stopping. This avoids fluctuations in the torque output to the drive wheels DW at a timing that is not intended by the driver of the vehicle 1.

In addition, in the control device 30 of this embodiment, the completion of the transition to the slip state of the lock-up clutch 134 is determined by the actual slip ratio (ETR) of the lock-up clutch 134 falling below a predetermined value, or by the rotational speed difference between the rotational speed NE of the crankshaft 11a (input shaft of the lock-up clutch 134) and the rotational speed (NM) of the main shaft 141 (output shaft of the lock-up clutch 134) becoming greater than a predetermined value. Alternatively, as described above, the completion of the transition of the lock-up clutch 134 to the slip state may be judged by the passage of a predetermined time from the timing of the instruction to transition to the slip state.

According to this configuration, it is possible to more accurately determine when the lock-up clutch 134 has completed the transition to slip control. Therefore, it is possible to more effectively prevent fluctuations in the torque output to the drive wheels DW at a timing that is not intended by the driver of the vehicle 1, and it is possible to more reliably avoid deterioration of the NV characteristics of the vehicle 1.

In addition, in the control device 30 of this embodiment, when switching from the damping control implementation state to the damping control non-implementation state, the target engagement torque (target ETR=S1) of the lock-up clutch 134 during the period (from the time when the command to shift from the engagement state to the slip state is issued to the time when the shift to the slip state is completed) is set to be lower than the target engagement torque (target ETR=S2) of the lock-up clutch 134 after the establishment of the non-vibration control non-execution state.

According to this configuration, when switching from the vibration control implementation state to the vibration control non-implementation state, by setting the target engagement torque of the lock-up clutch 134 from the engagement state to the slip state to a value lower than the target engagement torque of the lock-up clutch 134 after the vibration control non-implementation state is established, the response of the slip ratio at the time of the transition to the slip state can be improved, it is possible to complete the transition to the slip state more quickly and reliably. In other words, when switching from the damping control implementation state to the damping control non-implementation state, it is necessary to complete the transition of the lock-up clutch 134 to the slip state as quickly as possible, and by setting the target engagement torque of the lock-up clutch 134 to a value lower than the target engagement torque after the damping control non-implementation state is established, it is possible to transition to the slip state more quickly in a shorter time.

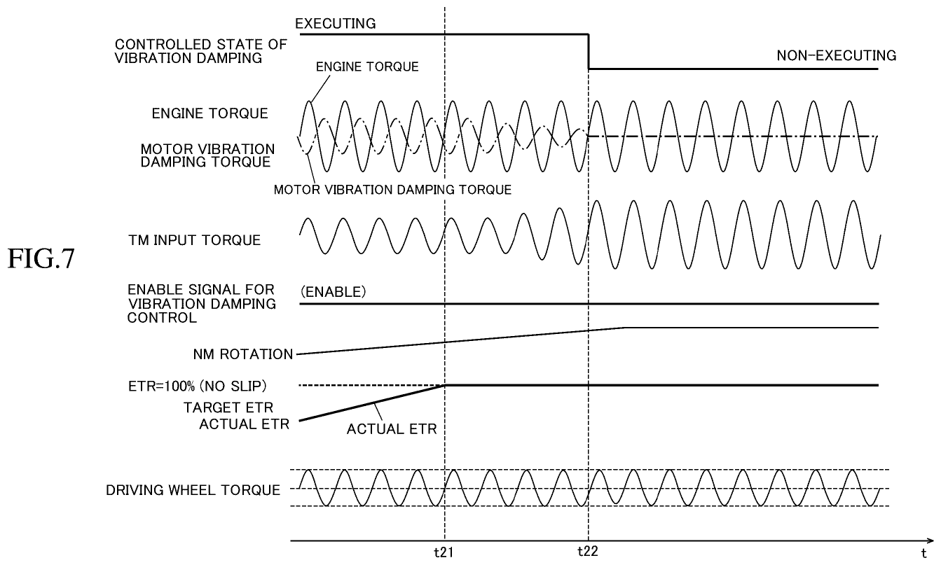

FIG. 7 shows a comparison example of the present invention's control, and is a timing chart showing the case where the switch from the damping state to the non-damping state is performed for reasons such as the damping control being outside the area where damping control is required. In the timing chart of the same figure, the change in the damping control state (implementation/non-implementation), engine torque and motor damping torque, transmission™ input torque, damping control enable signal (enable/disable), the main shaft rotation speed (NM rotation), the slip ratio ETR (target ETR, actual ETR) of the lock-up clutch 134, and the output torque to the driving wheel DW (driving wheel torque), are shown as changes over time t.

In the graph of FIG. 7, the lock-up clutch 134 is engaged at time t21, and before time t22, the motor vibration control is being implemented with the lock-up clutch 134 engaged. In this case, we are assuming a situation where the vehicle is in a high-speed range where the MN rotation (main shaft rotation) and other rotation speeds are relatively high, and where the effect on the NV of the vehicle 1 is small even if the amount of slip of the lock-up clutch 134 is reduced and it is in a locked state. In this state, at time t22, it is judged that the vehicle 1 has entered a region (non-vibration control region) where the NV characteristics of the vehicle 1 can be satisfied without motor vibration control and without slip of the lock-up clutch 134, and the vibration control implementation state is switched from “implementation” to “non-implementation”. In addition, as a result, the output of the motor vibration control torque by the motor generator 12 is stopped. Furthermore, before and after the state of the vibration control implementation is switched from “implementation” to “non-implementation”, the vibration control enable signal is always in the “enable” state, and the lock-up clutch 134 is always engaged.

In the example graph in FIG. 7, when the state of the vibration control implementation is switched from “implementation” to “non-implementation”, there is no transition period as in the example in FIG. 6, and immediately stops the output of the vibration suppression torque by the motor generator 12. However, in the first place, when the main shaft rotation speed is in the high-speed rotation region where the rotation speed is relatively high, even if the slip amount of the lock-up clutch 134 is reduced and the connection state is made, the driving wheel DW torque is maintained in a stable state when the vibration suppression control implementation state is switched to the vibration suppression control non-implementation state, and it does not cause deterioration of the NV characteristics of the vehicle 1 at the time of switching.

The above describes an embodiment of the present invention, but the present invention is not limited to the above embodiment, and various changes are possible within the scope of the claims and the technical ideas described in the specification and drawings.

For example, in the above-mentioned embodiment, the engine 11 and the motor generator 12 are connected via the crankshaft 11a, but this is not limited as such. For example, the motor generator 12 may be connected to a drive shaft that rotates as one unit with the drive wheel DW.

1. A vehicle control device that controls a vehicle, including: an internal combustion engine; an electric motor; drive wheels, and a lock-up clutch provided in a power transmission path extending from the internal combustion engine and electric motor to the drive wheels,
wherein the internal combustion engine is configured to switch between all-cylinder operation (in which all cylinders are operated) and idling cylinder operation (in which some cylinders are stopped), and
the lock-up clutch can be in a locked state (in which the output from at least one of the internal combustion engine and the electric motor is transmitted to the drive wheels with high efficiency), or in a slip state (in which the output is transmitted to the drive wheels with lower efficiency than in the locked state), and
the vehicle control device is configured such that
when the internal combustion engine is in idling operation, the vehicle control device is capable of executing motor vibration control, which outputs vibration control torque from the electric motor (that includes torque in reverse phase to the engine torque output from the internal combustion engine), as vibration control to reduce the torque vibration of the internal combustion engine transmitted to the drive wheels, and
the vehicle control device is configured such that when switching from a vibration damping control implementation state (in which the lock-up clutch is in the engaged state and the motor vibration damping control is implemented) to a vibration damping control non-implementation state (in which the lock-up clutch is in the slip state and the motor vibration damping control is not implemented), the following operation will be executed: the vehicle control device issues a command to the lock-up clutch to move from the engaged state to the slip state, continues to implement the motor damping control until the transition to the slip state is complete, and terminates the motor damping control when judging that the transition to the slip state is complete.

2. The vehicle control device according to claim 1, wherein the vehicle control device determines that the transition to the slip state of the lock-up clutch has been completed when the rotational speed difference between the input shaft and output shaft of the lock-up clutch has reached a predetermined value or more.

3. The vehicle control device according to claim 1, wherein the vehicle control device determines that the shift to the slip state of the lock-up clutch has been completed when the rotational speed ratio between the input shaft and output shaft of the lock-up clutch has fallen below a predetermined value.

4. The vehicle control device according to claim 1, wherein the vehicle control device determines that the shift to the slip state of the lock-up clutch has been completed when a predetermined time has elapsed from the timing of the instruction to shift to the slip state.

5. The vehicle control device according to claim 1, wherein the vehicle control device is configured such that when switching from the vibration control implementation state to the vibration control non-implementation state, the vehicle control device will set the target engagement torque of the lock-up clutch during the period from the issuance of the command to switch from the engagement state to the slip state (with respect to the lock-up clutch) to the completion of the transition to the slip state to a value which is lower than the target engagement torque of the lock-up clutch after the establishment of the vibration control non-implementation state.
